(19) United States
(12) Patent Application Publication
(10) Pub. No.: US 2006/0116927 A1
(43) Pub. Date: Jun. 1, 2006

(54) Method of creating and implementing a marketing plan for a retail store chain with measurable profit enhancement

(75) Inventors: Harmon B. Miller III, Atlanta, GA (US); James P. Matthews, Atlanta, CA (US); Robert B. Kennedy, Atlanta, GA (US)

Correspondence Address: H. JAY SPIEGEL, P.O. BOX 11, Mount Vernon, VA, 22121, US

(73) Assignee: Miller Zell, Inc.

(21) Appl. No.: 11/000,025

(22) Filed: Dec. 1, 2004

(51) Int. Cl. G06Q 30/00

(52) U.S. Cl. 705/14

(57) ABSTRACT

A method of creating and implementing a marketing plan for a retail store chain includes the steps of developing a media and marketing plan tailored for the specific needs of a retail store chain including concentration on marketing of high margin products, implementing the plan in the retail store chain, measuring gross sales and gross profits for stores in the chain including determining whether the plan has enhanced gross sales and gross profits. Responsive to the determining step, the plan is modified in a modified plan designed to enhance gross sales and gross profits. Once the plan has been modified, the modified plan is then implemented. The process is repeated through measurement of gross sales and gross profits for the modified plan, with subsequent modification and implementation of that plan. In this way, the plan is substantially perfected to maximize measurable enhancements in gross sales and profits of a retail store chain.

### BACKGROUND OF THE INVENTION

The present invention relates to a method of creating and implementing a unique marketing plan for a retail store chain, which measurably benefits the shopper, the store and the branded (supplier or retailers) product with measurable profit enhancement.

Retail store chains depend upon marketing professionals, whether in-house or employed by outside marketing consulting firms, to provide guidance as to how to successfully market a large variety of products and sometimes services. Numerous approaches and techniques are employed by marketing professionals in devising marketing plans for such establishments with the goal of enhancing profitability of the retail chains for whom they are employed. However, to date, all such marketing plans have one thing in common—they are unable to effectively predict enhanced profits and are unable to measure enhanced profitability.

As marketing expenses increase year-by-year, increasingly, advertisers want to know what they are paying for and what they are getting for the money they pay. Marketing professionals in a climate of increasing competition must find a way to tangibly predict success when advertisers follow their marketing plans.

Many retailers need to deliver measured change in some way due to existing business challenges. New pressures exist for retailers and brand purveyors that did not previously exist. These pressures are caused by media proliferation and result in increased accountability, with audiences being harder to reach. Brand purveyors have to work harder now than they did before, but there are fewer options for them to do so. As such, a new focus is emerging from both retailers and brand purveyors to maximize every asset, every contact opportunity from consumers, as well as every message. Retailers have found that there is an untapped financial value and a latent revenue opportunity resulting from the actual presence of customers in their stores. If a retailer could communicate with customers present in their stores, by providing shoppers an evident benefit resulting in steering the customer to desired purchases, enhanced profitability would result. Additionally, often the retailers own private label or unlabeled merchandise such as produce, and these products bear the greatest profit margins. The ability to steer customers within the retail establishment to add-on items and to higher profit margin items inherently enhances the profitability of a retail establishment. Furthermore, signage or other displays encouraging the purchaser of one product to also purchase another product, in a cross-selling or up-selling action, increases gross sales of a retail establishment and, inherently, profitability, while providing the shopper with menu ideas and information now lacking in such establishments.

In supermarkets as they are set up today, point of purchase display material consists of an unfocused mix of materials from retailers as well as vendors. Retailers typically use only 50-60% of the marketing materials produced by vendors, thereby leaving 40-50% of those materials wasted.

In the past, vendors depended on mass media, principally television and newspaper advertising, to drive brand awareness and create sell-through at retail. Given the proliferation of mass media, there has been a dramatic reduction in the effectiveness of mass media to reach consumers while costs have greatly increased. The cost per ad has continued to increase while the number of households reached continues to decline significantly. This phenomenon has caused the value of the store itself as the medium for selling merchandise to be increasingly important, thereby making in-store promotional activity that much more important, such that the role of traditional item(s) oriented point-of-purchase displays must be converted to become a new store-wide media experience that informs and sells.

The vast majority of in-store promotions are developed by branded marketers, thereby causing such promotions to be limited in focus promoting mostly their own brand while avoiding or ignoring the possibilities of cross-selling or up-selling because they are unaware that cross-selling and/or up-selling can enhance their bottom line. The situation today is most all point-of-purchase messages sell only the product(s) the vendor wants to sell. The situation today is there is no unified, customer benefit oriented media for: (1) cross-selling—promoting fresh vegetables and the appropriate dressings, etc., and (2) selling poultry items and suggesting menu pleasing fruits and vegetables. As a result, in-store promotions generally consist of a hodge-podge of uncoordinated and confusing communications that frequently fail to enhance profitability of a store and do not encourage consumers to cross purchase products that they may not be aware go together.

The notion of marketing and advertising on the part of a retail store chain takes on several forms including those that encourage shoppers to visit a store and those that steer shoppers toward shopping patterns desirable to the proprietor, once the shoppers have arrived within the store. If a marketing method could be devised that would subtly cause shoppers to purchase more merchandise than they intended to purchase and-higher margin items, such a plan would enhance profitability.

If a marketing plan were able to educate consumers as to products that are compatible with other products, such education would encourage higher dollar amounts per customer purchase and thereby enhance profitability.

If a marketing plan were devised that provided customers with signage or other displays enabling the customers to easily find different categories of products that are compatible with one another, in a purchase, such customers would be more satisfied and their increased purchases would enhance profitability.

It is with these thoughts in mind that the present invention was developed.

### SUMMARY OF THE INVENTION

The present invention relates to a method of creating and implementing a marketing plan for a retail store chain with benefits for shoppers as well as measurable profit enhancement for the store and increased sales for higher margin product providers. The present invention includes the following interrelated objects, aspects and features:

(1) The present invention contemplates changing the method by which the creative design work of marketing professionals is executed, converting the disparate point-of-purchase messages from various vendors into a unified media experience to modify the process by which consumers shop within a retail establishment.

(2) The present invention contemplates development of regularly scheduled, whole store themed, in-store communications programs such as those directed to meal planning and/or value meals, and which may also be event driven such as based upon holidays or recurring events such as birthdays, anniversaries, and significant events such as baptisms, bar mitzvahs as well as, hopefully, one time occasions such as weddings.

(3) The inventive method focuses on the total assortment of he retailer's product offerings and is not limited to any specific brand or product category. The program unfolds throughout the entire store and may, if possible, concentrate on those products such as house brands or unbranded products that often afford the retailer the highest relative profit margin.

(4) The inventive method leverages selling techniques such as cross-selling and selling up and promotes the purchase of new items about which consumers may not initially be aware. Thus, for example, when a consumer decides to purchase a turkey, signage encourages that purchaser to go to another area of the store where the consumer can purchase not only cranberry sauce but interesting stuffings and salads, fresh vegetables, desserts, cheeses, etc. Alternatively, for the purpose of such a promotion, the cranberry sauce and menu ideas can be stocked adjacent the turkeys.

(5) Signage, again, could be used to promote sales of higher margin house brands and unbranded categories such as produce. The inventive method would, in effect, cause fresh fruit areas such as fruits, vegetables, meats, poultry, seafood, dairy, beverages, bakery, deli and natural foods to be effectively branded. In these particular areas, cross-selling and up-selling are highly effective, and also drastically enhance profitabilty of a store since they inherently reduce wastage that occurs when all of the inventory of such time limited products is discarded after a date certain.

(6) Some aspects of the inventive method provide value-added ideas to the shopper such as menu ideas, healthy food recommendations, recipe ideas, information concerning different food groups that are compatible with one another, etc.

(7) The inventive method can be coordinated with specific vendors who, as a result, can expect greater store support and higher sales when their media display materials are integrated into specific themes devised in accordance with the teachings of the present invention. The informative unified themes displayed at the store reduce cluttering that is caused by the presence of uncoordinated displays.

(8) The present invention contemplates incorporating visual messages on all printed materials, interactive and digital messages and displays, interior in-store messages on all materials, and exterior store lot messages presenting the theme proposition, thereby building traffic and anticipation of message benefits. The present invention has virtually unlimited flexibility. A key aspect of the present invention consists of professional installation of new and removal of old point-of-purchase media, thereby, again, reducing cluttering while enhancing the effectiveness of such displays.

(9) Any marketing plan created in accordance with the teachings of the present invention includes coordination of installation and removal of advertising and promotion media to ensure that the desired total integration visual impact to the shopper drives sales of targeted higher margin items and lines.

(10) The present invention benefits three critical constituencies simultaneously. First, it provides consumers a more informative, productive and interesting shopping experience. Second, it benefits the store itself by driving increased store sales and profit margins across the entire store. Third, it permits vendors to logically receive prime space in terms of location and facings, and the benefits of cross-selling to promote the entire portfolio of the vendor's brand. Additionally, the present invention creates a holistic context for using the store as a targeted selling medium and provides a platform for continuous improvement, new concepts, usage of new technologies and other product initiatives.

Through use of the inventive method, in-stock levels are increased by relieving the delivery truck driver of time-consuming display installations. Instead, display installations are carried out by either store personnel or marketing professionals, thereby ensuring 95%+installation vs. the present 50-60%.

In an essential aspect of the present invention, through use of the present invention, increases by item, line and total store may be accurately measured as a result of practicing the teachings of the present invention.

(11) The present invention operates under several distinctive principles. First, program measurement is focused on increasing sales and margins. Employment of the teachings of the present invention results in higher sales and margins for the retailer and data demonstrating these facts can be sourced directly from the retailer's point-of-sale system and/or sales tracking systems. Second, the focus is on steering the customers to purchase higher margin products across the total store with a distinct focus on store brands as well as unbranded products such as fresh products including produce. Third, the practice of the present invention is uniquely benefit-based providing an integrated series of benefits to core retail constituents, namely, consumers, retailers and branded marketers (vendors). Fourth, the focus of the present invention encompasses the total store, not just one product or category, and allows for cross-promoting of products across categories and outside of their traditional departments.

(12) Fifth, the present invention leverages a unique combination of direct selling techniques helping to guide the impulse shopper through the store. Sixth, the present invention establishes a store-wide changeable dynamic platform for consumer information that responds to client needs and is focused on occasions and mind-sets and supplements the retailer's existing price/item signage. The present invention establishes a tactical total store media plan to coordinate scheduling, placement and formatting for in-store media. It augments and does not replace existing in-store customer communication programs. It provides a single source agency plan extending “from soup to nuts,” encompassing strategy, planning, creation, production, program management, installation, measurement and renewal.

Seventh, the present invention is based upon consumer and time relevant themes, and is driven by holidays, seasons, as well as situational occasions such as birthdays, anniversaries, bar mitzvahs, confirmations, baptisms, etc. Eighth, the present invention provides micro-marketing capability allowing for the use of tailored media based upon demographic and geographical profiles. Tenth, the teachings of the present invention may increase media usage from 60-95%. Professional installation and renewal of marketing materials within the retail environment results in higher percentage of media placement and usage resulting in accurate in-store media measurement and lower per unit utilization costs.

(13) The present invention contemplates a close interface between marketing professionals and retail store management as well as employees of retail stores. After a media and marketing plan has been developed, it is implemented within the retail store environment. After implementation, results are measured and, based upon those results, modifications to the media and marketing plan are proposed and completed. Based upon those modifications, feedback is given, resulting in amendments to the media and marketing plan and implementation of those amendments. In a continuous loop, the media and marketing plan is continually tweaked and modified based upon measured results so that it is optimized on a continuous basis.

Accordingly, it is a first object of the present invention to provide a method of creating and implementing a marketing plan for a retail store chain with measurable profit enhancement.

It is a further object of the present invention to provide such a method in which the consumer is given a more satisfying, healthier, informative, interesting, productive and impulsive shopping experience.

It is a still further object of the present invention to provide media and marketing plans that benefit the three core retail constituents, namely, consumers, retailers and branded marketers.

It is a still further object of the present invention to provide such a method that establishes a dynamic platform for providing of consumer information in response to client needs, occasions and mind-sets, and supplements rather than replacing the retailer's existing signage and displays.

It is a still further object of the present invention to provide such a method in which enhancement of sales volume and profits are distinctly measurable.

It is a yet further object of the present invention to provide such a method in which marketing professionals continually monitor retail store performance and modify the media and marketing plan in response to data received so that the media and marketing plan is continually first improved and then implemented.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a schematic representation of the relationship between marketing professionals and a retailer in,practicing the teachings of the present invention.

FIG. 2 shows a sequence of steps that are undertaken in developing a media and marketing plan in accordance with the teachings of the present invention.

FIG. 3 shows a schematic representation of the series of steps that are implemented in accordance with the teachings of the present invention to implement a media and marketing plan.

FIG. 4 shows a schematic representation of the steps that are undertaken in taking measurements of the results of implementation of a media and marketing plan.

FIG. 5 shows a schematic representation of various aspects of a media and marketing plan.

FIG. 6 shows a typical spreadsheet created in accordance with the teachings of the present invention to plan placements of displays within a store.

### SPECIFIC DESCRIPTION OF THE PREFERRED EMBODIMENT

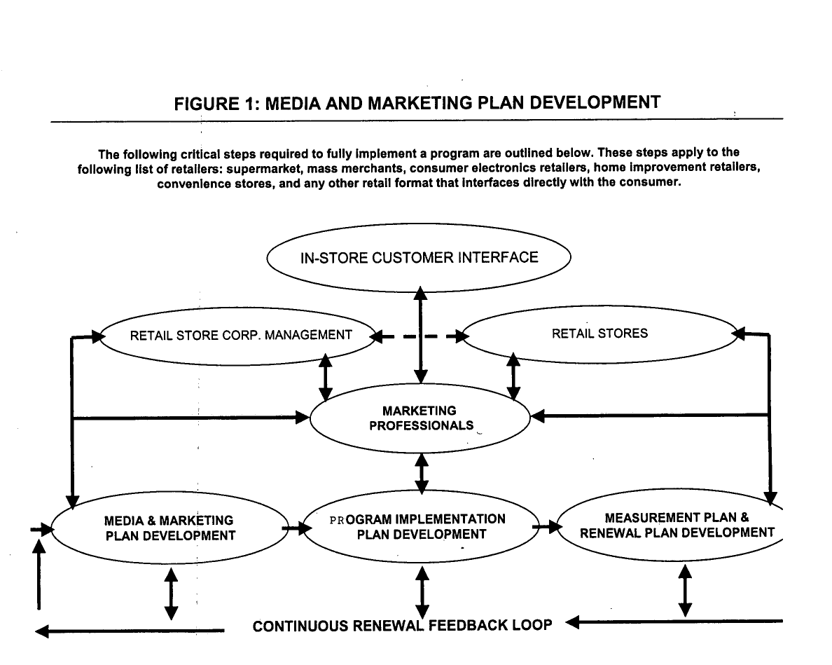

With reference, first, to FIG. 1, a schematic representation is provided that shows the relationship between marketing professionals and a retail establishment as well as an overview of the sequence of events that occurs when practicing the inventive method.

As seen in FIG. 1, the marketing professionals interface with retail store management as well as the retail stores and receive input from customers via an in-store customer interface. The marketing professionals create a media and marketing plan and that plan is transmitted to the retail store management which communicates with the marketing professionals until such time as the media and marketing plan is approved. Once the media and marketing plan is approved, it is implemented by the marketing professionals at the retail store level.

After implementation, the marketing professionals measure the results accruing through application of the media and marketing plan including comparison of gross sales and gross profits prior to implementation of the plan and gross sales and gross profits after implementation of the plan. This information is transmitted to the marketing professionals as well as to the retail store management. Discussions then ensue between the marketing professionals and the retail store management as to ways in which the media and marketing plan may be altered to enhance its effectiveness. Once those discussions have been completed, which constitute the continuous renewal feedback loop shown in FIG. 1, the originally prepared media and marketing plan is appropriately modified to take into account the actual measured results and then the modified plan is implemented by the marketing professionals. Results are again measured and discussions are again had with retail store management and the plan may, if desired, be, again, modified and then re-implemented.

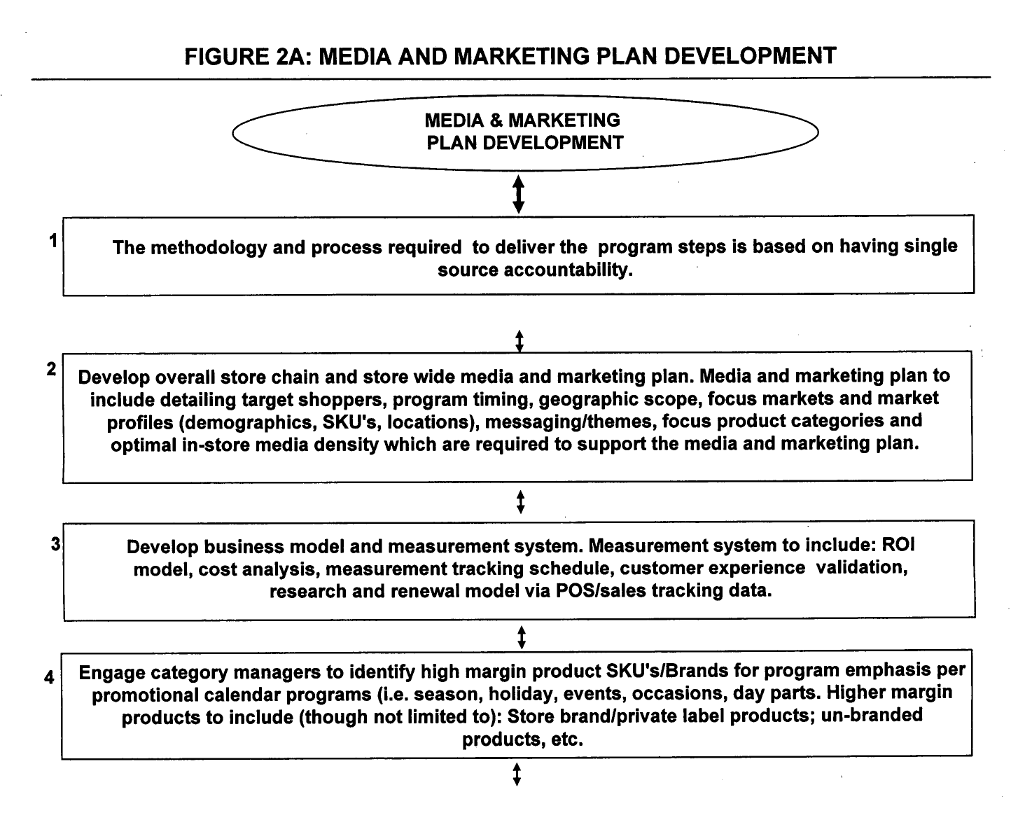

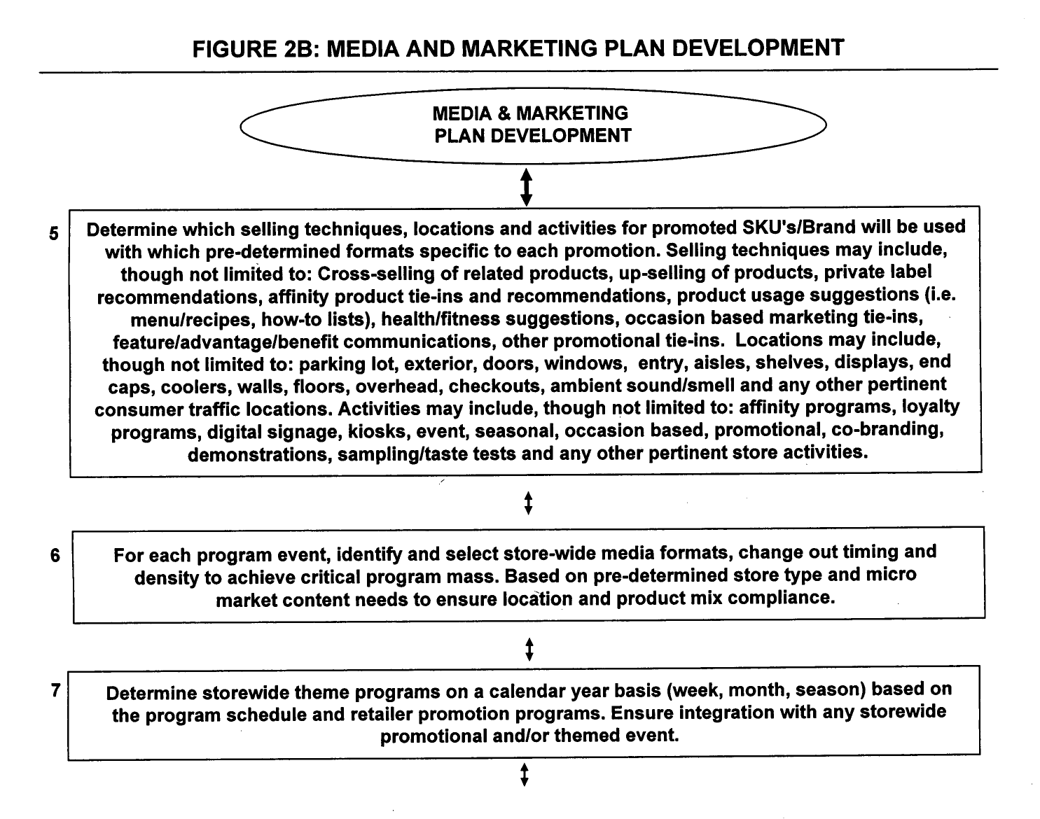

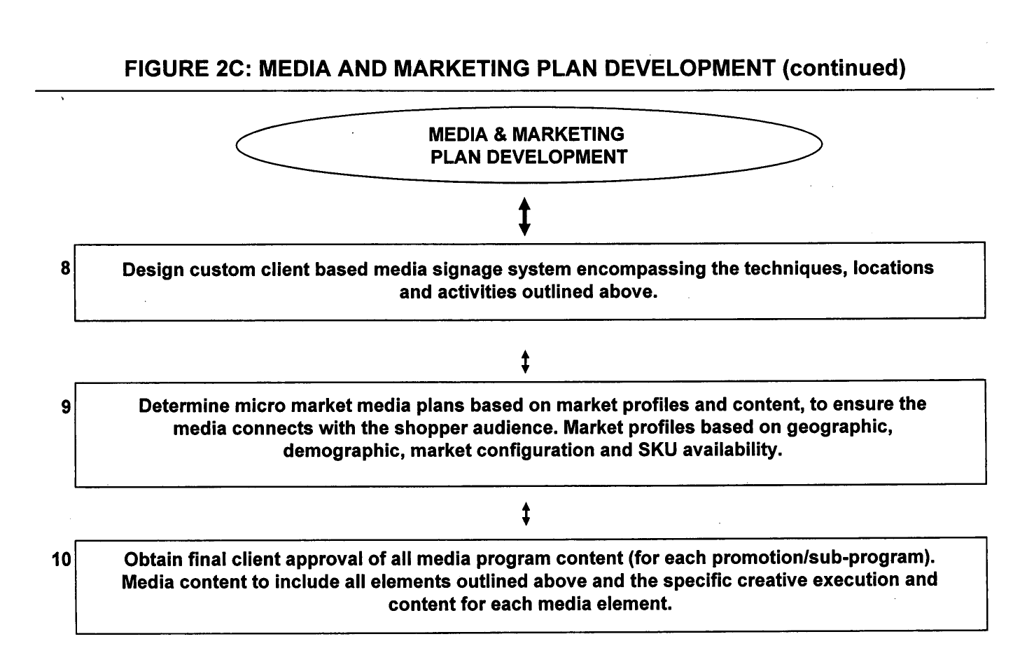

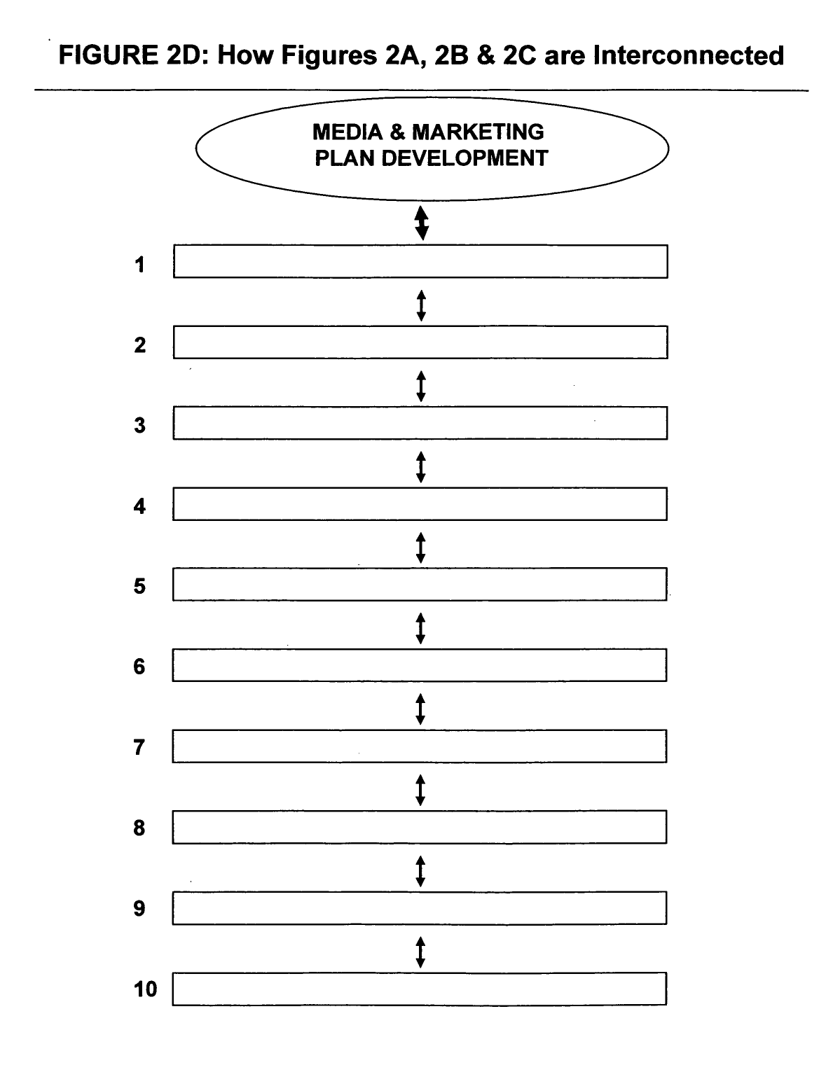

With reference, now, to FIG. 2, the preferred steps undertaken in developing the media and marketing plan will now be explained. In developing the overall store chain and store-wide media and marketing plan, it is essential to include detailing that targets shoppers demographically in terms of such aspects as age, income and ethnicity. The plan includes focus on program timing such as seasonal, weekly or monthly, event driven such as holidays, birthdays, anniversaries, etc., takes into account geographic scope, whether local, regional or national, and focus markets and market profiles taking into account demographics SKUs (stock keeping units) and locations, messaging/themes, focus product categories and optimal in-store media density including the quantity of displays that will be employed.

With further reference to FIG. 2, the methodology and process required to deliver the inventive program steps is based upon having single source accountability. In order to develop the media and marketing plan for a retail establishment, a business model is created and a system of tangibly measuring results is devised. The measurement system includes ROI model, cost analysis, measurement tracking schedule, customer experience validation, research and renewal model via point-of-sale sales tracking data.

Next, category managers are engaged to identify high margin product SKUs and brands for emphasis during promotional calendar programs such as seasonal, holiday driven, events and occasions. Emphasis is made on higher margin products including but not limited to store brands, private label products and unbranded products such as produce. Retail establishments often use discounts and sales as a marketing technique. Thus, “higher margin” can actually mean selling products at their regular price without having to discount them.

Next, the marketing professionals determine which selling techniques, locations and activities for promoted SKUs/brands will be used, and which predetermined formats, specific to each promotion, will be employed in conjunction with each SKU and/or brand. Selling techniques may include, though not be limited to, cross-selling of related products, up-selling of products, private label recommendations, affinity product tie-ins and recommendations, product usage suggestions such as cross-selling to complete menus and/or recipe items, “how-to” lists, health/fitness suggestions, occasion based marketing tie-ins, feature/advantage/benefit communications, other promotional tie-ins. Locations where selling techniques are employed may include parking lots, exterior doors, windows, entry locations, aisles, shelves, displays, end caps, coolers, walls, floors, overheads, check-outs, ambient sound/smell, and any other pertinent consumer traffic locations. Activities may include affinity programs, loyalty programs, digital signage, video display screens, audio programs, kiosks, different events, seasonal or occasion based in nature, promotional events, co-branding, demonstrations, sampling/taste tests, and any other pertinent store activities.

Where a program event is employed as a marketing technique, the marketing professionals identify and select store-wide media formats, the timing of changing of displays, and the density of displays to achieve critical program mass. These decisions are based upon predetermined store type and micro-market content needs to ensure location and product mix compliance.

Next, store-wide theme programs are determined on a calendar year basis with the frequency being by the week, month or season. These decisions are integrated with store-wide promotions and/or themed events for maximum effectiveness.

Based upon the techniques, locations and activities set forth hereinabove, custom client based media signage and displays are designed. Displays may include audio or visual with visual including signs as well as video displays.

Next, micro-market media plans are determined based upon market profiles and content to ensure that the media that are employed connect with the shopping audience. Market profiles are based upon geographic factors as well as the demographic factors for each particular retail establishment. Other factors to be considered include market configuration and SKU availability.

Once all of the above aspects have been completed, they are outlined for the client retail store management so that final approval can be obtained for each aspect. The information furnished to the clients includes the specific plan for implementation and execution.

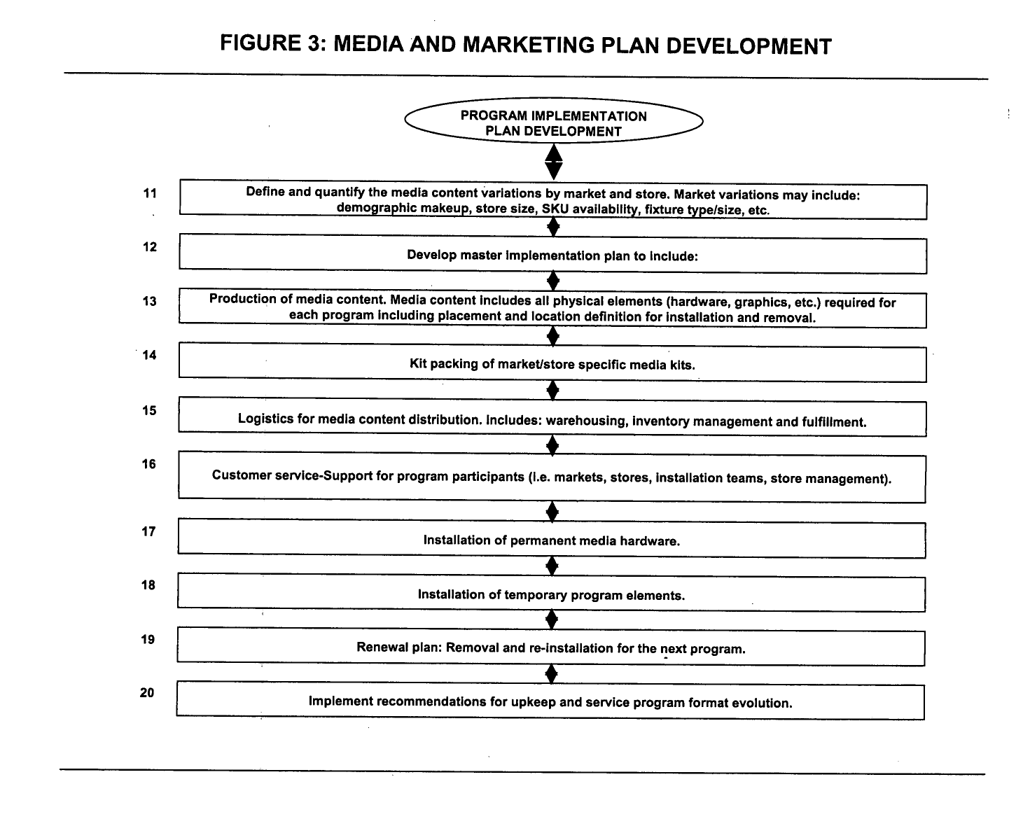

With reference, now, to FIG. 3, the preferred steps in implementing the media and marketing plan will now be explained.

In a first aspect, with regard to the entire retail store chain, the media content for each particular store is defined and quantified including by consideration of the market. Market variations taken into account include demographic make-up, store size, SKU availability, fixture type/size, and any other relevant market variation criteria. Next, a master implementation plan is developed which includes production of the media content including all physical elements consisting of hardware, graphics, etc. required for each program including placement and location definition for installation and removal. The master implementation plan also includes kit packing of market/store specific media kits and planning for logistics for media content distribution including warehousing, inventory management, and fulfillment. The master implementation plan also includes customer service support for program participants, that is, markets, stores, installation teams, and store management as well as installation of permanent media hardware and installation of temporary program elements. The program implementation plan also includes a renewal plan that facilitates removal of existing media and re-installation or new installation for the next program to be undertaken. Finally, recommendations are implemented for upkeep of displays and service program format evolution.

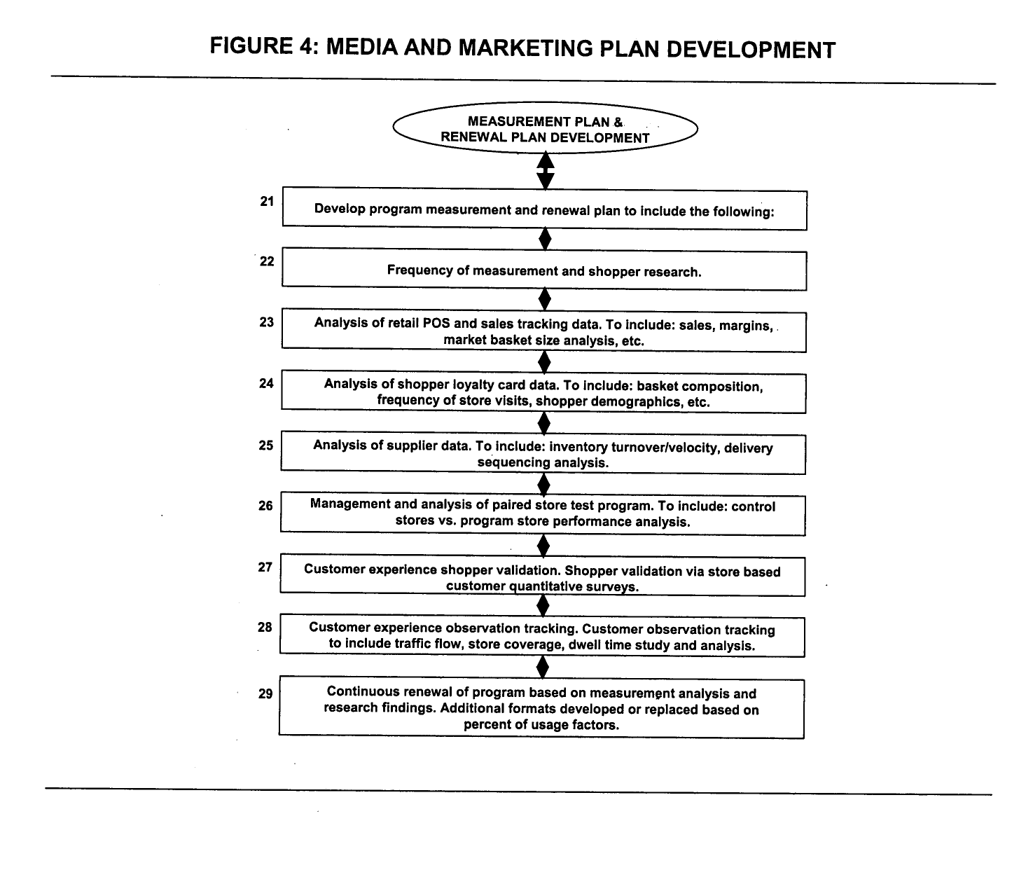

With reference, now, to FIG. 4, the measurement plan and renewal plan development aspects will now be explained. A program measurement and renewal plan is developed including deciding the frequency of measurement and the frequency of conducting shopper research. Point-of-sale retail sales including sales tracking data are compiled. Point-of-sale and sales tracking data includes total sales, margins, market basket, size analysis, etc. If the marketing plan includes use of shopper loyalty cards, data derived from those cards based upon shoppers shopping in the retail establishment is analyzed. The analysis includes basket composition, frequency of store visits, shopper demographics, if available, and any other pertinent criteria.

Supplier data is analyzed including inventory, turnover, and inventory velocity, delivery sequencing analysis, etc. For example, Wal-Mart has a lower profit margin than other retailers, however, typically, Wal-Mart has a higher turnover rate, that is, merchandise is replenished to inventory more often in a given time period than is the case for higher margin competitors.

If a paired store test program has been included in the media and marketing plan, analysis of results from that test program is undertaken including comparison and performance of a control store where none of the marketing efforts in accordance with the teachings of the present invention are undertaken as compared to a store where the inventive method is being practiced.

Validation of customer experience shoppers is undertaken and tracking of customer experience observations is accomplished. Concerning validation of customer experience shoppers, this is accomplished via store based customer quantitative surveys. Concerning tracking of customer experience observations, this is accomplished through analysis of traffic flow, store coverage, dwell time, and any other relevant criteria.

The inventive program is continuously renewed based upon measurement analysis and research findings. Additional formats are developed or replaced based upon percent of usage factors.

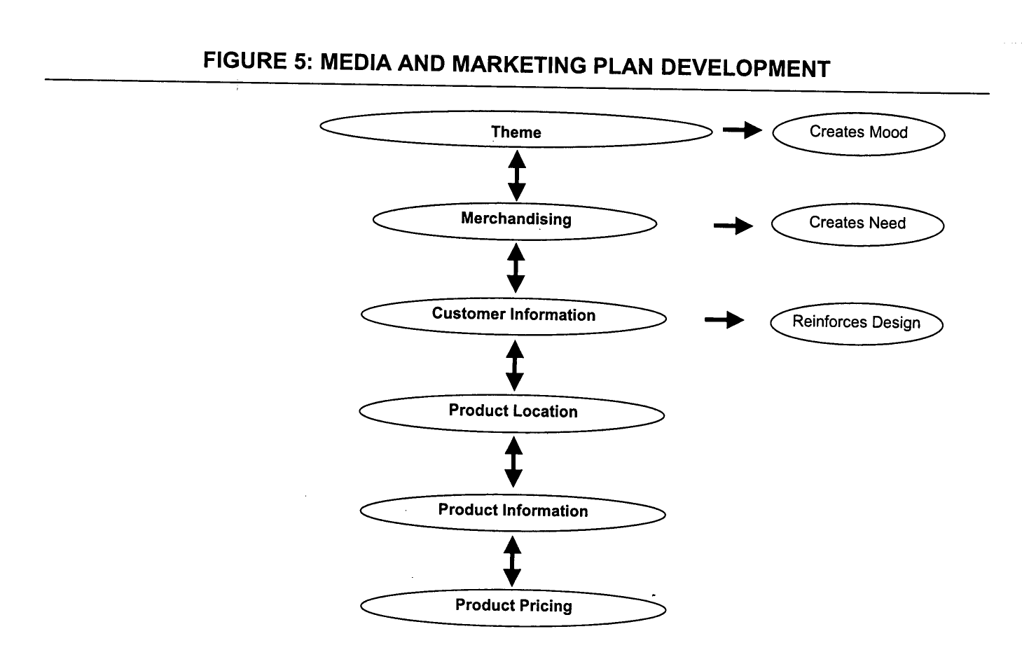

With reference to FIG. 5, certain aspects of development of the media and marketing plan will be better understood. As understood from FIG. 5, when the media and marketing plan is under development, the marketing professionals must keep focused on the desire that the plan creates a mood in the retail store environment, creates a need on the part of shoppers to purchase different items responsive to the media and marketing plan that encourages cross-selling, up-selling, etc. Information about customers of a particular retail establishment reinforces the media and marketing plan to enhance its effectiveness. Data received during the research phase of the present invention best facilitates product location and the kinds of information about products that is provided to shoppers. Additionally, product pricing is suitably set based upon researched criteria.

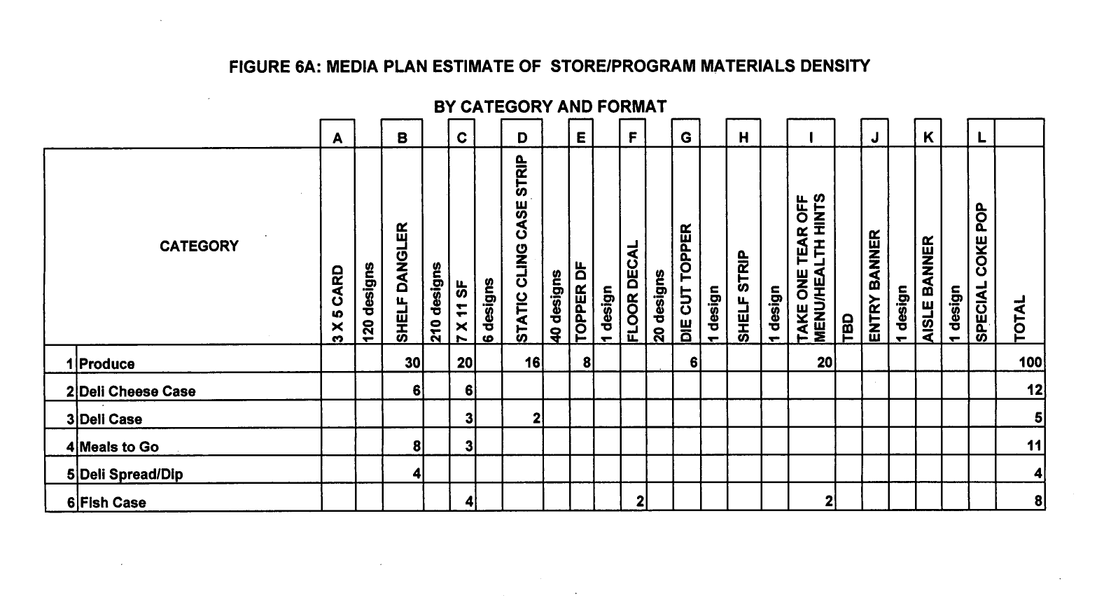

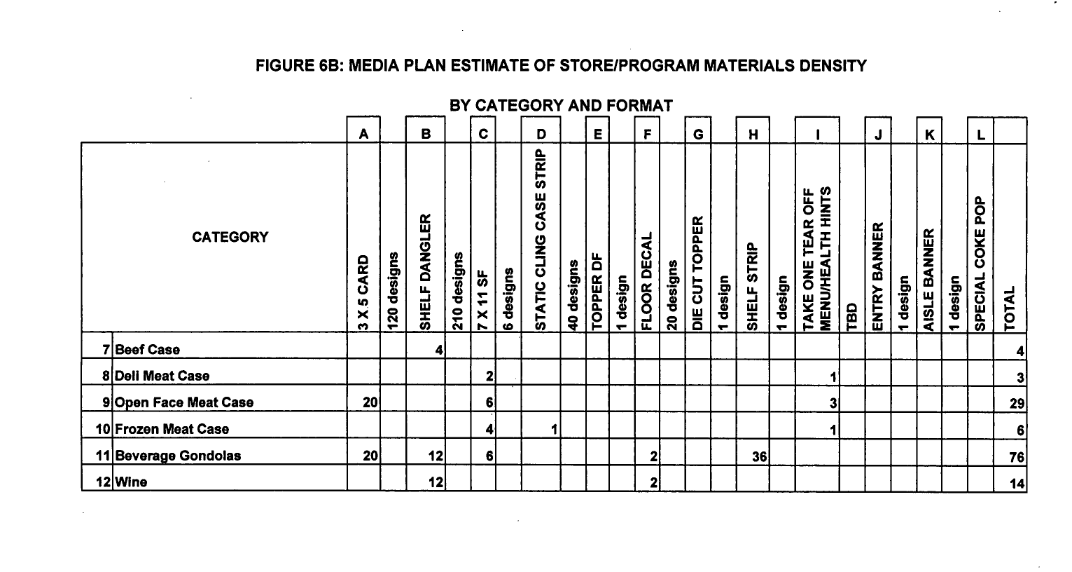

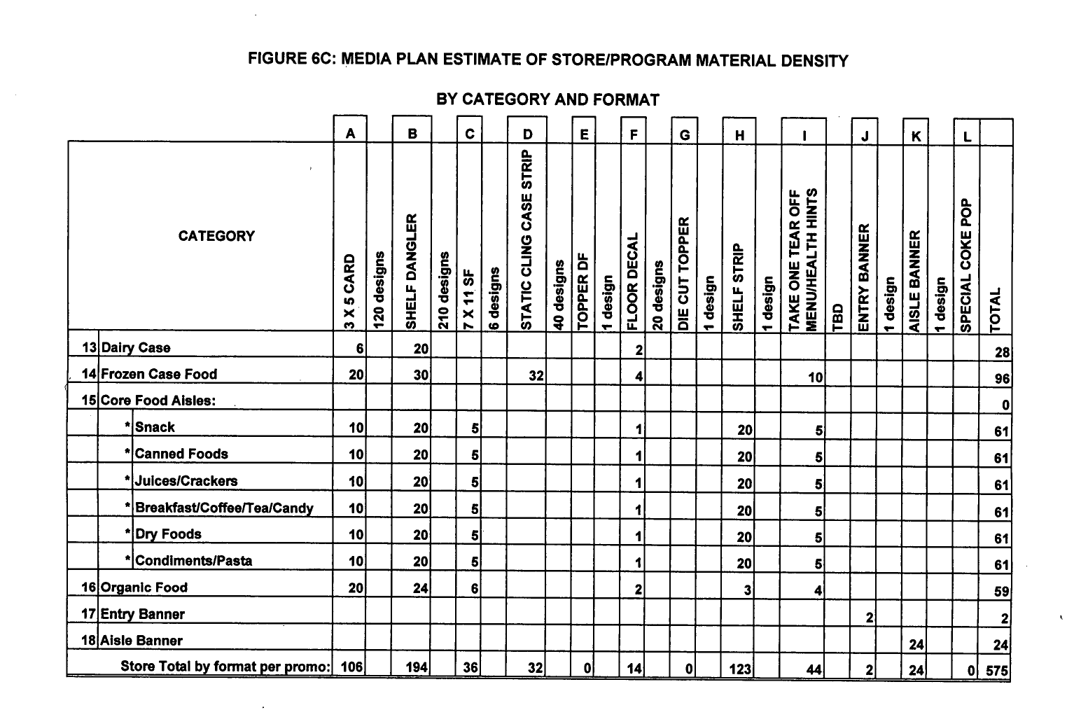

FIG. 6 shows a chart created during the process of developing the media and marketing plan with such a chart being produced for each separate store in the retail chain. The plan illustrated in FIG. 6 shows the variety of different types of displays that will be employed, the variety of locations and categories within the store where the displays will be located, and the number of each type of display located at each location. Such a plan is provided at each retail store so that the marketing professionals can install the displays in accordance with a chart such as that which is illustrated in FIG. 6.

In accordance with the teachings of the present invention, the experience of the customer within the retail store is entirely focused on linking the desire of the shopper for more timely information at the place where they can best use the information with the desire of the store to clean up the in-store visuals. The present invention transforms point-of-purchase into becoming a media that sells what the store most wants to sell by focusing on house brands as well as merchandise that is typically unbranded such as fruits, vegetables, meat, poultry, seafood, dairy, deli and bakery, thereby, in effect, branding those fresh items. Through up-selling and cross-selling, the teachings of the present invention subtly and subconsciously cause the consumer to purchase more items and a larger variety of items and at a higher profit margin than they were intending to purchase when they first entered the retail store, even when they come to the store with their own prepared shopping list. The results accruing through implementation of the present invention are distinctly measurable and reproducible, and the present invention facilitates tweaking and modifying the initially prepared media and marketing plan to improve it based upon feedback obtained through implementation of the plan.

As such, an invention has been disclosed in terms of a preferred embodiment thereof which fulfills each and every one of the objects of the invention as set forth hereinabove, and provides a new and useful method of creating and implementing a marketing plan for a retail store chain with measurable profit enhancement of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method of creating and implementing a marketing plan for a retail store chain including the steps of:
a) developing a media and marketing plan tailored for the specific needs of a retail store chain including concentration on marketing of high margin products;
b) implementing said plan in said retail store chain;
c) measuring gross sales and gross profits for stores in said chain including determining whether said plan has enhanced gross sales and gross profits;
d) responsive to said determining step, modifying said plan in a modified plan designed to enhance gross sales and gross profits;
e) implementing said modified plan; and
f) repeating steps c, d and e.

2. The method of claim 1, wherein said developing step includes the step of creating a business model and measurement system, said measurement system including use of techniques chosen from the group consisting of cost analysis, measurement tracking schedule, ROI model, customer experience validation, and research and renewal model via point-of-sale and sales tracking data.

3. The method of claim 1, wherein said developing step includes the step of engaging category managers of said retail store chain to identify high margin products to be emphasized.

4. The method of claim 3, wherein said engaging step is carried out in accordance with promotional calendar programs chosen from the group consisting of seasonal, holiday driven, event driven, and occasion driven programs.

5. The method of claim 1, wherein said developing step includes the step of determining particular selling techniques that will be used in each particular store of said chain, said selling techniques including one or more chosen from the group consisting of cross-selling of related products, up-selling of products, private label recommendations, affinity product tie-ins, product usage suggestions such as menus, recipes, and how-to lists, health and fitness suggestions, occasion-based marketing tie-ins, and feature/advantage/benefit communications.

6. The method of claim 5, wherein said developing step includes the step of determining which selling techniques will be employed at particular locations in each store of said chain, said locations including one or more chosen from the group consisting of parking lots, other exterior locations, doors, windows, aisles, shelves, displays, end caps, coolers, walls, floors, overhead locations, and check-outs.

7. The method of claim 5, wherein said determining step includes the step of choosing activities to be used in promoting sale of high margin products, said activities including one or more activities chosen from the group consisting of affinity programs, loyalty programs, digital signage, video displays, kiosks, co-branding, product demonstrations, and sampling and taste tests.

8. The method of claim 1, wherein said developing step includes the step of designing custom client-based signage.

9. The method of claim 1, wherein said developing step includes the step of determining micro-market media plans based upon market profiles of the shopper audience, said market profiles being determined based upon information including one or more chosen from the group consisting of geographic, demographic, market configuration, and SKU availability information.

10. The method of claim 1, wherein said implementing step includes the steps of defining and quantifying media content variations by market and store, said market variations including one or more chosen from the group consisting of demographic make-up, store size, SKU availability, and fixture type and size.

11. The method of claim 10, wherein said implementing step includes the step of production of media content.

12. The method of claim 11, wherein said implementing step includes the step of installation of permanent media hardware and temporary program elements.

13. The method of claim 1, wherein said measuring step includes the step of determining the frequency of conducting measurements and shopper research.

14. The method of claim 13, wherein said measuring step includes the step of analyzing retail point-of-sale and sales tracking data, said analyzing step including consideration of one or more criteria chosen from the group consisting of gross sales, gross margins, and market basket size analysis.

15. The method of claim 14, wherein said analyzing step further includes the step of analyzing shopper loyalty card data and supplier data, said step of analyzing shopper loyalty card data including analysis of one or more criteria chosen from the group consisting of basket composition, frequency of store visits, and shopper demographics.

16. A method of creating and implementing a marketing plan for a retail store chain including the steps of:
a) developing a media and marketing plan tailored for the specific needs of a retail store chain including concentration on marketing of high margin products, said developing step including the step of creating a business model and measurement system, said measurement system including use of techniques chosen from the group consisting of cost analysis, measurement tracking schedule, ROI model, customer experience validation, and research and renewal model via point-of-sale and sales tracking data, said developing step further including the step of determining particular selling techniques that will be used in each particular store of said chain, said selling techniques including one or more chosen from the group consisting of cross-selling of related products, up-selling of products, private label recommendations, affinity product tie-ins, product usage suggestions such as menus, recipes, and how-to lists, health and fitness suggestions, occasion-based marketing tie-ins, and feature/advantage/benefit communications;
b) implementing said plan in said retail store chain, said implementing step further including the steps of defining and quantifying media content variations by market and store, said market variations including one or more chosen from the group consisting of demographic make-up, store size, SKU availability, and fixture type and size;
c) measuring gross sales and gross profits for stores in said chain including determining whether said plan has enhanced gross sales and gross profits, said measuring step further including the steps of determining the frequency of conducting measurements and shopper research, and analyzing retail point-of-sale and sales tracking data, said analyzing step including consideration of one or more criteria chosen from the group consisting of gross sales, gross margins, and market basket size analysis;
d) responsive to said determining step, modifying said plan in a modified plan designed to enhance gross sales and gross profits;
e) implementing said modified plan; and
f) repeating steps c, d and e.

17. The method of claim 16, wherein said developing step further includes the step of engaging category managers of said retail store chain to identify high margin products to be emphasized.

18. The method of claim 16, wherein said implementing step includes the step of installation of permanent media hardware and temporary program elements.

19. The method of claim 18, wherein said implementing step further includes the step of production of media content.

20. The method of claim 16, wherein said developing step includes the step of engaging category managers of said chain to identify high margin products to be emphasized, said engaging step being carried out in accordance with promotional calendar programs chosen from the group consisting of seasonal, holiday driven, event driven, and occasion driven programs.
